(19) United States
(12) Patent Application Publication
(10) Pub. No.: US 2013/0326034 A1
(43) Pub. Date: Dec. 5, 2013

(54) PCRF RULE ROLLBACK DUE TO INSUFFICIENT RESOURCES ON A DOWNSTREAM NODE

(71) Applicants: Shanawaz SHAIK, Ottawa (CA); Darryl W. JAAKKOLA, Carp (CA); Kugendran SABARATNAM, Kanata (CA)

(72) Inventors: Shanawaz SHAIK, Ottawa (CA); Darryl W. JAAKKOLA, Carp (CA); Kugendran SABARATNAM, Kanata (CA)

(73) Assignee: ALCATEL-LUCENT CANADA INC., Ottawa (CA)

(21) Appl. No.: 13/483,567

(22) Filed: May 30, 2012

(51) Int. Cl. G06F 15/16

(52) U.S. Cl. 709/223; 709/228

(57) ABSTRACT

Various exemplary embodiments relate to a method performed by a policy and charging rules node (PCRN) device. The method may include: establishing a first service data flow for an application function having a first Policy and Control Charging (PCC) rule including a first parameter within a session; receiving a request to upgrade the first parameter of the service data flow; generating a second PCC rule including an upgraded parameter; storing the first PCC rule in a cache; sending the second PCC rule to a Policy and Charging Enforcement Node (PCEN); receiving acknowledgement that the second PCC rule has been installed at the PCEN; receiving an indication that the second PCC rule failed at a downstream node; and sending the first PCC rule stored in the cache to the PCEN.

### TECHNICAL FIELD

Various exemplary embodiments disclosed herein relate generally to telecommunications networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks, leading to a less-than-elegant solution. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications that describe the Policy and Charging Rules Function (PCRF), Policy and Charging Enforcement Function (PCEF), and Bearer Binding and Event Reporting Function (BBERF) of the EPC. These specifications further provide some guidance as to how these elements interact in order to provide reliable data services and charge subscribers for use thereof.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a policy and charging rules node (PCRN) device. The method may include: establishing a service data flow for an application function, the service data flow having a first Policy and Control Charging (PCC) rule including a first parameter; receiving a request to upgrade the first parameter of the service data flow; generating a second PCC rule including an upgraded parameter; storing the first PCC rule in a cache; sending the second PCC rule to a Policy and Charging Enforcement Node (PCEN); receiving acknowledgement that the second PCC rule has been installed at the PCEN; receiving an indication that the second PCC rule failed at a downstream node; and sending the first PCC rule stored in the cache to the PCEN.

In various alternative embodiments, the step of establishing a first service data flow may include: receiving a request from an application function including a requested parameter; generating a first PCC rule including the requested parameter as the first parameter; and sending the first PCC rule to the PCEN.

In various alternative embodiments, the step of storing the first PCC rule in a cache may include: storing the PCC rule first parameter in association with the rule name of the second PCC rule, a session id, and a timestamp. The method may further include: running a timer to periodically trigger cleanup of the cache; comparing a timestamp for a stored PCC rule with a timeout threshold; and removing the stored PCC rule from the cache if the timestamp exceeds the timeout threshold.

In various alternative embodiments, the step of storing the first PCC rule may include: determining that the cache is full; removing a stored PCC rule having an oldest timestamp; and replacing the removed PCC rule with the first PCC rule.

In various alternative embodiments, the method may further include: determining that a session has been terminated; and removing a PCC rule stored in the cache having a session-id matching the session that has been terminated.

In various alternative embodiments, the method may further include: storing the first PCC rule in a current rule storage; replacing the first PCC rule in the current rule storage with the second PCC rule; and replacing the second PCC rule in the current rule storage with the first PCC rule stored in the cache.

Various exemplary embodiments relate to a Policy and Charging Rules Node (PCRN). The PCRN may include: a current rule storage including a plurality of rule objects, each rule object having a rule name of an active PCC rule; and a rollback cache including at least one rule object having an identical rule name as a rule object in the current rule storage and a timestamp indicating a time that the rule object was stored in the cache.

In various alternative embodiments, the rollback cache may be a reserved portion of a generic cache memory and the rollback cache may have a configurable size.

In various alternative embodiments, the rollback cache includes only rule objects that have a parameter requiring fewer resources than a corresponding parameter of the rule object in the current rule storage having an identical rule name.

Various exemplary embodiments relate to a tangible and non-transitory machine-readable storage medium encoded with instructions for execution by a policy and charging rules node (PCRN) device. When executed, the instructions stored on the tangible and non-transitory machine-readable storage medium may perform the above described method.

### BRIEF DESCRIPTION OF THE DRAWINGS

In order to better understand various exemplary embodiments, reference is made to the accompanying drawings, wherein:

FIG. 1 illustrates an exemplary subscriber network;

FIG. 2 illustrates an exemplary Policy and Charging Rules Node;

FIG. 3 illustrates a message diagram showing an exemplary method of rolling back a Policy and Charging Control (PCC) rule;

FIG. 4 illustrates a flowchart showing an exemplary method of managing a rollback cache; and

FIG. 5 illustrates an exemplary data structure for a rollback cache.

To facilitate understanding, identical reference numerals have been used to designate elements having substantially the same or similar structure and/or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

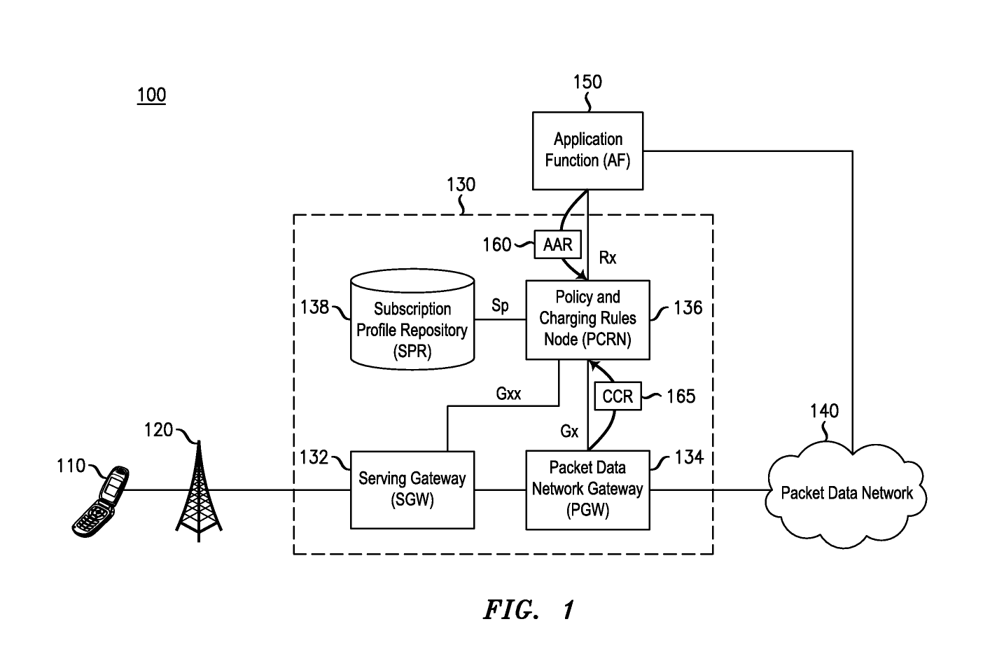

FIG. 1 illustrates an exemplary subscriber network 100 for providing various data services. Exemplary subscriber network 100 may be a telecommunications network or other network for providing access to various services. Exemplary subscriber network 100 may include user equipment 110, base station 120, evolved packet core (EPC) 130, packet data network 140, and application function (AF) 150.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 may include a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP standards. Accordingly, EPC 130 may include a serving gateway (SGW) 132, a packet data network gateway (PGW) 134, a policy and charging rules node (PCRN) 136, and a subscription profile repository (SPR) 138.

Serving gateway (SGW) 132 may be a device that provides gateway access to the EPC 130. SGW 132 may be the first device within the EPC 130 that receives packets sent by user equipment 110. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Policy and charging rules node (PCRN) 136 may be a device or group of devices that receives requests for application services, generates PCC rules, and provides PCC rules to the PGW 134 and/or other PCENs (not shown). PCRN 136 may be in communication with AF 150 via an Rx interface. As described in further detail below with respect to AF 150, PCRN 136 may receive an application request in the form of an Authentication and Authorization Request (AAR) 160 from AF 150. Upon receipt of AAR 160, PCRN 136 may generate at least one new PCC rule or may update the existing PCC rule for fulfilling the application request 160.

PCRN 136 may also be in communication with SGW 132 and PGW 134 via a Gxx and a Gx interface, respectively. PCRN 136 may receive an application request in the form of a credit control request (CCR) 170 from SGW 132 or PGW 134. As with AAR 160, upon receipt of a CCR 170, PCRN may generate at least one new PCC rule for fulfilling the application request 170. In various embodiments, AAR 160 and CCR 170 may represent two independent application requests to be processed separately, while in other embodiments, AAR 160 and the CCR may carry information regarding a single application request and PCRN 136 may create at least one PCC rule based on the combination of AAR 160 and the CCR 170. In various embodiments, PCRN 136 may be capable of handling both single-message and paired-message application requests.

Upon creating a new PCC rule or upon request by the PGW 134, PCRN 136 may provide a PCC rule to PGW 134 via the Gx interface using a CCA message. PGW 134 may determine whether PGW 134 is able to install the PCC rule. For example, PGW 134 may determine whether it has sufficient resources to process the additional service data flow. PGW 134 may send PCRN 136 a RAA message indicating whether the rule was successfully installed. In various embodiments, such as those implementing the proxy mobile IP (PMIP) standard for example, PCRN 136 may also generate QoS rules. Upon creating a new QoS rule or upon request by the SGW 132, PCRN 136 may provide a QoS rule to SGW 132 via the Gxx interface.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within EPC 130. Data stored by SPR 138 may include an identifier of each subscriber and indications of subscription information for each subscriber such as bandwidth limits, charging parameters, and subscriber priority.

Packet data network 140 may be any network for providing data communications between user equipment 110 and other devices connected to packet data network 140, such as AF 150. Packet data network 140 may further provide, for example, phone and/or Internet service to various user devices in communication with packet data network 140.

Application function (AF) 150 may be a device that provides a known application service to user equipment 110. Thus, AF 150 may be a server or other device that provides, for example, a video streaming or voice communication service to user equipment 110. AF 150 may further be in communication with the PCRN 136 of the EPC 130 via an Rx interface. When AF 150 is to begin providing known application service to user equipment 110, AF 150 may generate an application request message, such as an authentication and authorization request (AAR) 160 according to the Diameter protocol, to notify the PCRN 136 that resources should be allocated for the application service. This application request message may include information such as an identification of the subscriber using the application service, an IP address of the subscriber, an APN for an associated IP-CAN session, and/or an identification of the particular service data flows that must be established in order to provide the requested service. AF 150 may communicate such an application request to the PCRN 136 via the Rx interface.

AF 150 may upgrade a parameter of a SDF after it has been installed on PGW 134. An upgraded parameter may provide better QoS to a user by using additional resources of the communications network 100. An upgraded parameter may include any changed parameter that improves quality of service or requires additional network resources. For example, AF 150 may increase the bandwidth of a streaming video service in order to provide higher quality. As another example, AF 150 may decrease a maximum latency to make a game more responsive. In order to upgrade a parameter, AF 150 may send an additional AAR message indicating an update to the parameters. PCRN 136 may generate a new PCC rule having the same name with at least one upgraded parameter or update an existing PCC rule with a new bandwidth and send a RAR message with the new PCC rule to PGW 134. PGW 134 may install the new PCC rule and return an RAA message indicating success. A downstream node, however, may not be able to handle an upgraded parameter of the new PCC rule. A downstream node may include, for example, eNodeB 120, a mobility management entity (MME) (not shown), SGW 132, or a router or switch located within packet data network 140. If a downstream node is unable to handle an upgraded parameter of a PCC rule, the downstream node may notify PGW 134 using, for example, GPRS Tunneling Protocol (GTP). PGW 134 may notify PCRN 136 of the rule failure by generating a CCR message including a resource allocation failure AVP.

A resource allocation failure may pose a problem for PCRN 136 because the network 100 may be out of sync. In particular, PCRN 136, PGW 134, and AF 150 may have installed rules or set parameters indicating that a service data flow should use an upgraded parameter. Meanwhile, one or more downstream network nodes may have rejected the upgraded parameter and reserved resources for the service data flow using the original parameter. If AF 150 attempts to provide the service data flow using the upgraded parameter, the downstream node may be unable to process the service data flow, leading to poor QoE for the user. If PCRN 136 notifies AF 150 that the updated PCC rule has failed, AF 150 may be able to request a new SDF with parameters requiring fewer resources, but service may be interrupted, resulting in poor QoE for the user. Accordingly, it may be useful for the PCRN 136 to be able to rollback the service data flow and associated PCC rule to an earlier rule that the downstream node is able to process.

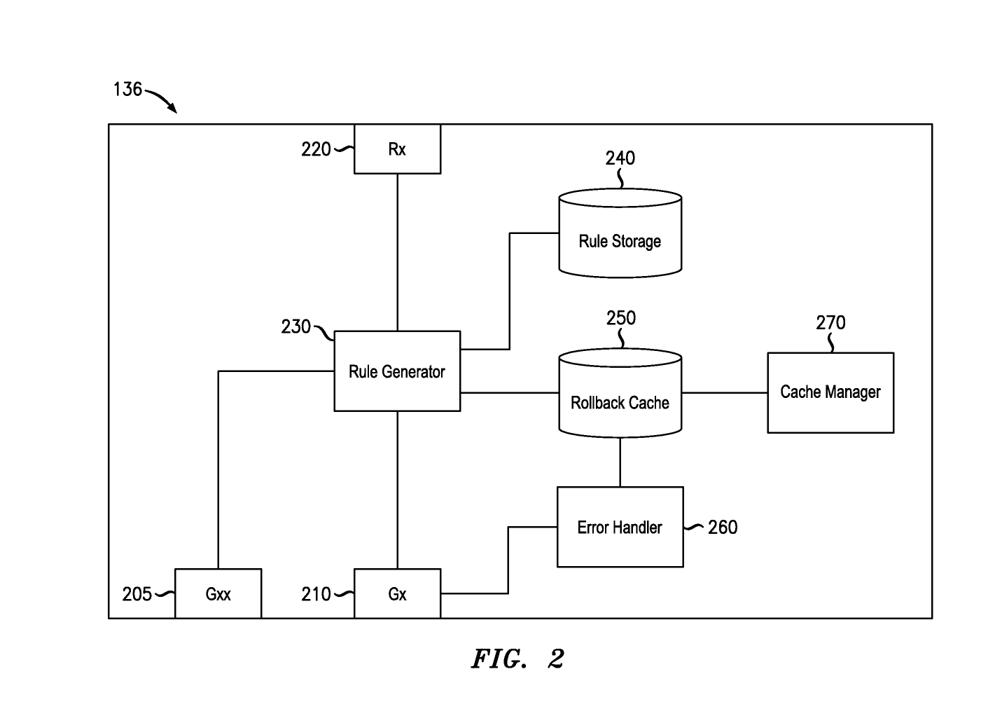

FIG. 2 illustrates an exemplary Policy and Charging Rules Node 136. PCRN 136 may include Gxx interface 205, Gx interface 210, Rx interface 220, rule generator 230, rule storage 240, rollback cache 250, and error handler 260.

Gxx interface 205 may be an interface comprising hardware and/or executable instructions encoded on a machine-readable storage medium configured to communicate with a serving gateway such as SGW 132. Such communication may be implemented according to the 3GPP specifications. For example, Gxx interface 205 may receive gateway control session establishment requests from SGW 132 and send QoS rules to SGW 132. Gxx interface 205 may also receive an indication from SGW 132 that resource allocation has failed at a downstream node.

Gx interface 210 may be an interface comprising hardware and/or executable instructions encoded on a machine-readable storage medium configured to communicate with a packet data network gateway, such as PGW 134. Such communication may be implemented according to the 3GPP specifications. For example, Gx interface 210 may receive IP-CAN session establishment requests and event messages from PGW 134 and send PCC rules to PGW 134. Gx interface 210 may also receive an indication from PGW 134 that resource allocation has failed at a downstream node.

Rx interface 215 may be an interface comprising hardware and/or executable instructions encoded on a machine-readable storage medium configured to communicate with a packet data network gateway, such as PGW 134. Such communication may be implemented according to the 3GPP specifications. For example, Rx interface 220 may receive AF session requests from AF 150.

Rule generator 230 may include hardware and/or executable instructions encoded on a machine-readable storage medium configured to generate PCC and/or QoS rules. Rule generator 230 may receive requests for rules from PCEN 134 and/or AF 150. Rule generator 230 may make policy decisions when generating rules. Rule generator 230 may determine whether network policies and subscriber profiles allow a requested service to be provided with requested parameters. When rule generator 230 has created a new rule, rule generator 230 may store the rule in rule storage 240.

Rule generator 230 may also determine whether a newly generated rule is an upgraded rule including an upgraded parameter. Rule generator 230 may compare the newly generated rule to a rule stored in rule storage 240 having the same rule name. Rule generator 230 may compare each parameter of the rules to determine whether any parameter has been upgraded to require additional resources or provide increased performance. If any parameter of the rule has been upgraded, the new rule may be considered an upgraded rule. When an upgraded rule is generated, rule generator 230 may copy the previous rule into rollback cache 250.

Rule storage 240 may be any machine-readable medium capable of storing information related to various rules. Accordingly, rule storage 240 may include a machine-readable storage medium such as read-only memory (ROM), random-access memory (RAM), magnetic disk storage media, optical storage media, flash-memory devices, and/or similar storage media.

Rollback cache 250 may be any machine-readable medium capable of storing information related to various rules. Accordingly, rollback cache 250 may include a machine-readable storage medium such as read-only memory (ROM), random-access memory (RAM), magnetic disk storage media, optical storage media, flash-memory devices, and/or similar storage media. In various embodiments, rollback cache 250 may be a high-speed cache memory such as a static cache. Rollback cache 250 may be part of a general purpose cache reserved for rollback purposes. The size of rollback cache 250 may be configurable. Rollback cache 250 may be managed by cache manager 270. Rollback cache 250 may temporarily store previous versions of upgraded rules in case a downstream node fails to allocate resources for the upgraded rule. A previous version may be removed from the rollback cache when it has timed out, when the rollback cache 250 is full, or when the related session is terminated.

Error handler 260 may include hardware and/or executable instructions encoded on a machine-readable storage medium configured to handle error messages received at PCRN 136. Error handler 260 may receive error messages in the form of CCR messages including a charging rule report indicating that a PCC rule has failed. In various alternative embodiments, error handler 260 may receive an error message in the form of a CCR message including a QoS rule report indicating that a QoS rule has failed. Error handler 260 may determine a PCC rule associated with the QoS rule has also failed. If the PCC rule has failed because of a downstream node failing to allocate resources, the CCR may include a resource allocation failure code within the charging rule report or QoS rule report. Upon receipt of a resource allocation failure code, error handler 260 may attempt to correct the error by rolling back to a previous version of the failed PCC rule. Error handler 260 may look up the failed rule in rollback cache 250. If rollback cache 250 includes a rule matching the name of the failed rule, error handler 260 may use the cached rule to replace the failed rule. Error handler 260 may send the cached rule to PGW 134. Error handler 260 may also update rule storage 240 to include the cached rule as the now active rule.

Cache manager 270 may include hardware and/or executable instructions encoded on a machine-readable storage medium configured to manage rollback cache 250. Cache manager 270 may monitor rollback cache 250 in order to minimize the size of rollback cache 250 and ensure integrity of the stored data. Cache manager 270 may be configured by a network operator to control rollback cache 250. A network operator may select a cache size, cleanup period, and cleanup threshold. The cache size may define a maximum size for the rollback cache 250. The maximum size may be defined in terms of a number of entries or a number of rule objects. A cleanup period may indicate how often cache manager 270 should perform a cleanup of rollback cache 250. A cleanup threshold may indicate an age of rule objects that are allowed to remain in the cache.

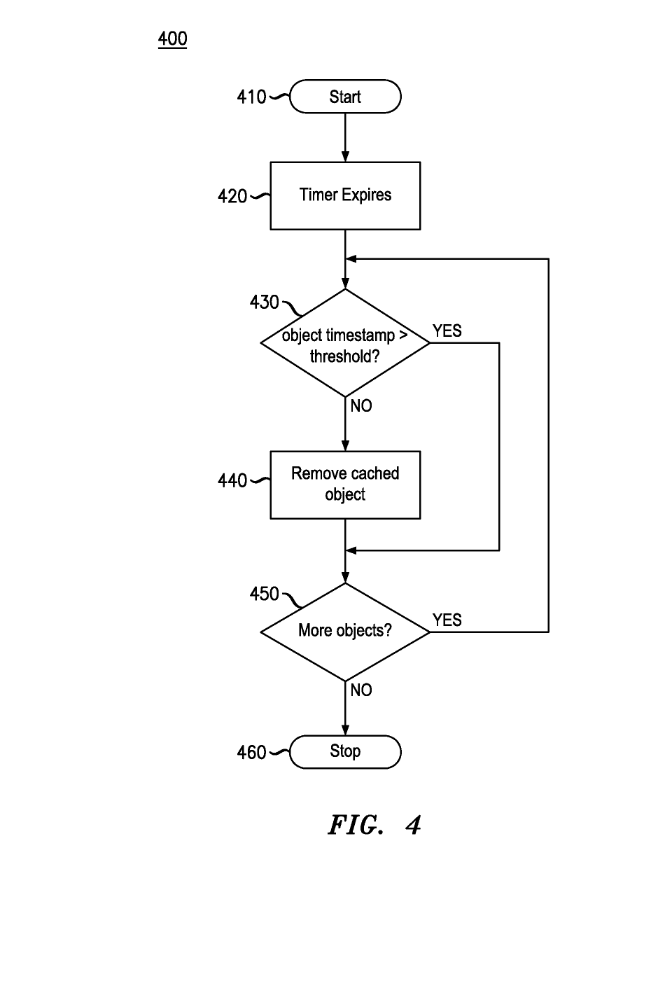

Cache manager 270 may remove an entry from rollback cache under three conditions. First, cache manager 270 may remove an entry when the cache is full and a new entry arrives. Cache manager 270 may select the oldest entry for removal using a least recently used algorithm. Second, cache manager 270 may remove an entry when a session associated with the entry has been terminated. Cache manager 270 may be notified of any terminated sessions and check the cache entries to determine whether any should be removed. Third, cache manager 270 may periodically cleanup the rollback cache. A method of cleaning up the rollback cache will be described in greater detail below regarding FIG. 4.

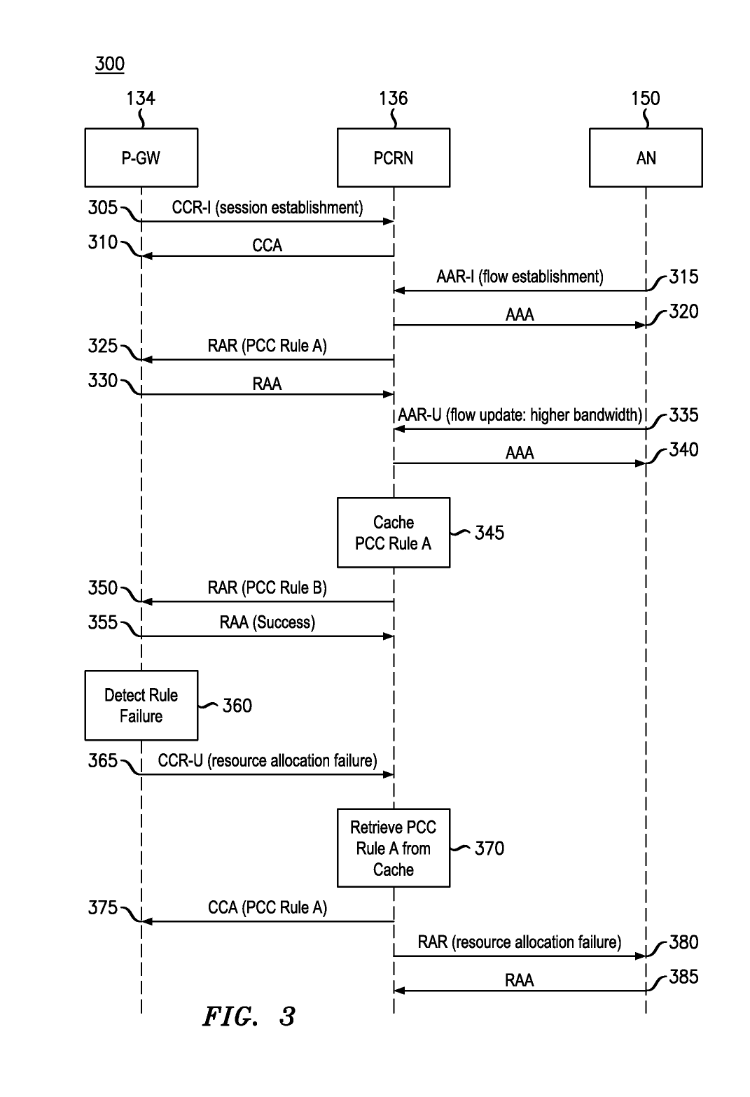

FIG. 3 illustrates a message diagram showing an exemplary method 300 of rolling back a Policy and Charging Control (PCC) rule. Method 300 may include sending and receiving messages from various network nodes including PGW 134 and AF 150. An arrow in FIG. 3 may represent a message. It should be apparent that an arrow may indicate a step of sending or receiving a message. Method 300 may be performed by the various components of PCRN 136.

Method 300 may begin at step 305, where PCRN 136 may receive an initial CCR message from PGW 134 seeking to establish an IP-CAN session for a user device 110. PCRN 136 may determine whether to create the IP-CAN session and also determine various properties of the session. In step 310, PCRN 136 may send PGW 134 a CCA message indicating that the IP-CAN session has been established.

In step 315, PCRN 136 may receive an initial AAR message from AF 150 with service data flow (SDF) establishment information. The flow establishment information may include flow parameters such as, for example, flow bandwidth. PCRN 136 may make a policy decision to determine whether the flow parameters are acceptable. PCRN 136 may generate a first PCC rule for the requested SDF. In step 320, PCRN 136 may send an AAA message to AF 150 indicating that the requested service data flow has been accepted.

In step 325, PCRN 136 may send a RAR message to PGW 134 including the first PCC rule for the SDF. PGW 134 may install the first PCC rule and also send additional messages to downstream nodes indicating that the downstream nodes should allocate resources for the SDF. In various embodiments, such as those implementing the PMIP standard, PCRN 136 may also generate a QoS rule based on the first PCC rule and send the QoS rule to SGW 132. In step 330, PGW may send an RAA message indicating that the first PCC rule was successfully installed.

In step 335, PCRN 136 may receive an AAR update message from AF 150 including updated parameters for the SDF. The updated parameters may be upgraded from the initial AAR. For example, the AAR update message may include a greater bandwidth parameter. PCRN 136 may make another policy decision to determine whether the updated flow parameters are acceptable. PCRN 136 may generate a second PCC rule including the updated parameters. The second PCC rule may have the same rule name as the first PCC rule. In step 340, PCRN 136 may send an AAA message to AF 150 indicating that the SDF has been updated.

In step 345, PCRN 136 may store the first PCC rule in the rollback cache 150. In various embodiments, PCRN 136 may store the first PCC rule only if the updated parameters of the second PCC rule require greater resources or provide increased performance compared to the original parameters of the first PCC rule. PCRN 136 may compare the second PCC rule to the first PCC rule to determine if the first PCC rule should be stored. PCRN 136 may require only one parameter of the second PCC rule to be greater than the corresponding parameter of the first PCC rule in order to cache the first PCC rule. PCRN 136 may also determine whether additional resources are required when making the policy decision to generate the second PCC rule.

In step 350, PCRN 136 may send PGW 134 a RAR message including the second PCC rule. PGW 134 may install the second PCC rule by replacing the first PCC rule in a local storage with the second PCC rule. Alternatively, the second PCC rule may not be stored until resources are allocated for the second PCC rule. PGW 134 may also send messages to downstream nodes indicating that the downstream nodes should allocate resources for the second PCC rule. In various embodiments, such as those implementing the PMIP standard, PCRN 136 may also generate a QoS rule based on the second PCC rule and send the QoS rule to SGW 132. In step 355, PGW 134 may send an RAA message indicating that the second PCC rule has been successfully installed. PGW 134 may send the RAA message immediately after installing the second PCC rule.

In step 360, PGW 134 may detect a rule failure for the second PCC rule. For example, PGW 134 may receive a message from a downstream node indicating that the resource allocation for the second PCC rule has failed or that the downstream node has insufficient resources. The downstream node may retain the previous allocation of resources used to satisfy the first PCC rule. The notification from the downstream node may arrive after PGW 134 has already sent the RAA message indicating that the second PCC rule has been successfully installed. Additionally, PGW 134 may have already replaced the first PCC rule with the second PCC rule in local storage. Accordingly, PGW 134 may not have a copy of the first PCC rule. The time between sending the RAA message and receiving notification from the downstream node may be relatively short because the notification may be generated when the downstream node attempts to allocate resources for the new rule. Accordingly, the time period may be measured in milliseconds. In various alternative embodiments, another node, such as SGW 132 may detect a resource allocation failure related to a QoS rule. Such a resource allocation failure may indicate that a PCC rule associated with the QoS rule has also failed.

In step 365, PCRN 136 may receive a CCR update message from PGW 134 indicating that the second PCC rule has failed. The CCR update message may include the rule name of the failed rule and a failure code. For example, the failure code may indicate that the second PCC rule failed because of resource allocation failure. The CCR update message may lack any information regarding the first PCC rule such as, for example, the parameters or resources that had been successfully allocated by downstream node. In various alternative embodiments, PCRN 136 may receive a CCR update message from SGW 132 indicating that a QoS rule associated with the second PCC rule has failed. PCRN 136 may determine the PCC rule name associated with the QoS rule and proceed as if it had received an indication that the PCC rule had failed.

In step 370, PCRN 136 may retrieve the first PCC rule from the rollback cache. PCRN 136 may compare the failed rule name received in step 365 with the cached PCC rules. If the rollback cache includes a matching rule name, PCRN 136 may set the cached first PCC rule as the active rule. PCRN 136 may copy the matching cached first PCC rule into rule storage 240. In various embodiments, PCRN 136 may remove the cached first PCC rule from rollback cache 250 after it has been reactivated.

In step 375, PCRN 136 may send PGW 134 a CCA message including the first PCC rule. PGW 134 may install the first PCC rule. In step 380, PCRN 136 may send a RAR message to AF 150 indicating that the updated SDF had a resource allocation failure. The resource allocation failure may relate to only the updated SDF. In other words, the original SDF may still be active and service may continue. The RAR message may indicate that AF 150 should revert to using the original SDF parameters. In step 385, AF 150 may send an RAA message acknowledging the RAR message. AF 150 may attempt to update the SDF parameters at any time by sending another AAR update message. The method 300 may end after step 385.

FIG. 4 illustrates a flowchart showing an exemplary method of managing a rollback cache. The method 400 may be performed by the various components of PCRN 136 including, for example, cache manager 270. Method 400 may begin at step 410 and proceed to step 420.

In step 420, PCRN 136 may detect that a timer has expired. The expiration of the timer may indicate that PCRN 136 should clean rollback cache 250. The method 400 may then proceed to step 430.

In step 430, PCRN 136 may compare a rule object timestamp with a threshold time. The threshold time may be based on the current time. For example, the threshold time may be configured as one minute before the current time. Accordingly, any timestamp that is more than one minute old may be less than the threshold time. If the object timestamp is less than or equal to the threshold time, the method 400 may proceed to step 440. If the object timestamp is greater than the object timestamp, the method 500 may skip to step 450.

In step 440, PCRN 136 may remove the cached object from the rollback cache 250. PCRN 136 may delete the object from the cache or mark the object as expired or invalid. Accordingly, a new object to be stored in the cache may use the location of the removed object. The method 400 may then proceed to step 450.

In step 450, PCRN 136 may determine whether there are additional objects stored in the cache that have not been examined. If there are additional objects in the cache, the method 400 may return to step 430. If all objects in the cache have been examined, the method 400 may proceed to step 460, where the method 400 ends.

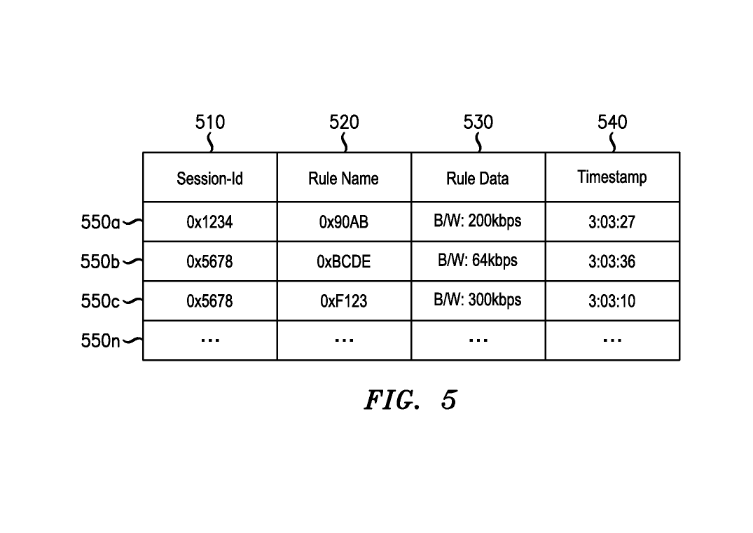

FIG. 5 illustrates an exemplary data structure 500 for a rollback cache. Data structure 500 may store rule objects that may be used as PCC rules. Data structure 500 may include fields for: session-id 510, rule name 520, rule data 530, and timestamp 540.

Session-id 510 may indicate a unique identifier of the IP-CAN session. The session-id may also be unique to the user device 110. There may be more than one rule associated with each session-id 510 because an IP-CAN session may include more than one SDF.

Rule name 520 may indicate a unique identifier for a PCC rule controlling a SDF. Because rollback cache 250 may include previous versions of PCC rules that have been upgraded, the rule name 520 may correspond to an identical rule name stored in a current rule storage.

Rule data 530 may indicate attributes of the stored PCC rule. Rule data 530 may include service data flow filters, precendence, gate status, QoS parameters, and/or charging keys. For simplicity, rule data 530 is shown in FIG. 5 as a bandwidth, which may represent a QoS parameter. Bandwidth may be divided into uplink and downlink directions. In various embodiments, rule data 530 may store a complete copy of all information used in a PCC rule. In various alternative embodiments, rule data 530 may store only QoS parameters or only modified QoS parameters.

Timestamp field 540 may indicate the time a rule object was stored in the rollback cache. Timestamp field 540 may use any format for encoding a time.

Data structure 500 may include multiple entries 550a-n. Each entry 550 may be a rule object including information regarding a PCC rule. Several exemplary rule objects may be seen in FIG. 5. Exemplary rule object 550a may be for a PCC rule in session “0x1234” named “0x90AB” allocated 200 kbps. Rule object 550a may have been placed in the data structure 500 at 3:03:27. Exemplary rule object 550b may be for a PCC rule in session “0x5678” named “0xBCDE” allocated 64 kbps. Rule object 550b may have been placed in the data structure 500 at 3:03:36. Exemplary rule object 550c may be for a PCC rule in session “0x5678” named “0xF123” allocated 300 kbps. Rule object 550a may have been placed in the data structure 500 at 3:03:10. Rule object 550b and rule object 550c may relate to two SDFs within the same session for a user device 110. Rule object 550n may indicate that data structure 500 may include additional rule objects as configured by a cache size.

The rule objects 550 within data structure 500 may be removed during the various processes described above. For example, if data structure 500 is full and PCRN 136 needs to cache a new rule object, cache manager 270 may remove rule object 550c, which may have the oldest timestamp. As another example, if cache manager 270 performs the cleanup procedure described above regarding FIG. 4 at 3:04, and the cleanup threshold is set to 30 seconds, cache manager 270 may remove rule objects 550a and 550c. If session “0x5678” is terminated, cache manager 270 may remove rule objects 550b and 550c.

According to the foregoing, various exemplary embodiments provide for a PCRN that may rollback a service data flow and associated PCC rule to an earlier rule that a downstream node is able to process. In particular, by caching a copy of a first PCC rule when the first PCC rule is upgraded to a second PCC rule, the PCRN may restore the first PCC rule if resource allocation fails for the second PCC rule.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a policy and charging rules node (PCRN) device, the method comprising:
establishing a service data flow for an application function, the service data flow having a first Policy and Control Charging (PCC) rule including a first parameter;
receiving a request to upgrade the first parameter of the service data flow;
generating a second PCC rule including an upgraded parameter;
storing the first PCC rule in a cache;
sending the second PCC rule to a Policy and Charging Enforcement Node (PCEN);
receiving acknowledgement that the second PCC rule has been installed at the PCEN;
receiving an indication that the second PCC rule failed at a downstream node; and
sending the first PCC rule stored in the cache to the PCEN.

2. The method of claim 1, further comprising informing an application function that the second PCC rule failed at a downstream node.

3. The method of claim 1, wherein the step of establishing a first service data flow comprises:
receiving a request from an application function including a requested parameter;
generating a first PCC rule including the requested parameter as the first parameter; and
sending the first PCC rule to the PCEN.

4. The method of claim 1, wherein the step of storing the first PCC rule in a cache comprises:
storing the PCC rule first parameter in association with the rule name of the second PCC rule, a session id, and a timestamp.

5. The method of claim 4, further comprising;
running a timer to periodically trigger cleanup of the cache;
comparing a timestamp for a stored PCC rule with a timeout threshold; and
removing the stored PCC rule from the cache if the timestamp exceeds the timeout threshold.

6. The method of claim 1, wherein the step of storing the first PCC rule comprises:
determining that the cache is full;
removing a stored PCC rule having an oldest timestamp; and
replacing the removed PCC rule with the first PCC rule.

7. The method of claim 1, further comprising:
determining that a session has been terminated; and
removing a PCC rule stored in the cache having a session-id matching the session that has been terminated.

8. The method of claim 1, further comprising:
storing the first PCC rule in a current rule storage;
replacing the first PCC rule in the current rule storage with the second PCC rule; and
replacing the second PCC rule in the current rule storage with the first PCC rule stored in the cache.

9. A Policy and Charging Rules Node comprising:
a current rule storage including a plurality of rule objects, each rule object having a rule name of an active PCC rule; and
a rollback cache including at least one rule object having an identical rule name as a rule object in the current rule storage and a timestamp indicating a time that the rule object was stored in the cache.

10. The Policy and Charging Rules Node of claim 9, wherein the rollback cache is a reserved portion of a generic cache memory, the rollback cache having a configurable size.

11. The Policy and Charging Rules Node of claim 9, wherein the rollback cache includes only rule objects that have a parameter requiring fewer resources than a corresponding parameter of the rule object in the current rule storage having an identical rule name.

12. A tangible and non-transitory machine-readable storage medium encoded with instructions for execution by a policy and charging rules node (PCRN) device, the tangible and non-transitory machine-readable storage medium comprising:
instructions for establishing a service data flow for an application function, the service data flow associated with a first Policy and Control Charging (PCC) rule including a first parameter;
instructions for receiving a request to upgrade the first parameter of the service data flow;
instructions for generating a second PCC rule including an upgraded parameter;
instructions for storing the first PCC rule in a cache;
instructions for sending the second PCC rule to a Policy and Charging Enforcement Node (PCEN);
instructions for receiving acknowledgement that the second PCC rule has been installed at the PCEN;
instructions for receiving an indication that the second PCC rule failed at a downstream node; and
instructions for sending the first PCC rule stored in the cache to the PCEN.

13. The tangible and non-transitory machine-readable storage medium of claim 12, wherein the step of establishing a first service data flow comprises:
instructions for receiving a request from an application function including a requested parameter;
instructions for generating a first PCC rule including the requested parameter as the first parameter; and
instructions for sending the first PCC rule to the PCEN.

14. The tangible and non-transitory machine-readable storage medium of claim 12, wherein the step of storing the first PCC rule in a cache comprises:
instructions for storing the PCC rule first parameter in association with the rule name of the second PCC rule, a session id, and a timestamp.

15. The tangible and non-transitory machine-readable storage medium of claim 14, further comprising;
instructions for running a timer to periodically trigger cleanup of the cache;
instructions for comparing a timestamp for a stored PCC rule with a timeout threshold; and
instructions for removing the stored PCC rule from the cache if the timestamp exceeds the timeout threshold.

16. The tangible and non-transitory machine-readable storage medium of claim 12, wherein the step of storing the first PCC rule comprises:
instructions for determining that the cache is full;
instructions for removing a stored PCC rule having an oldest timestamp; and
instructions for replacing the removed PCC rule with the first PCC rule.

17. The tangible and non-transitory machine-readable storage medium of claim 12, further comprising:
instructions for determining that a session has been terminated; and
instructions for removing a PCC rule stored in the cache having a session-id matching the session that has been terminated.

18. The tangible and non-transitory machine-readable storage medium of claim 12, further comprising:
instructions for storing the first PCC rule in a current rule storage;
instructions for replacing the first PCC rule in the current rule storage with the second PCC rule; and
instructions for replacing the second PCC rule in the current rule storage with the first PCC rule stored in the cache.
